(19) United States
(12) Patent Application Publication
(10) Pub. No.: US 2022/0381459 A1
(43) Pub. Date: Dec. 1, 2022

(54) AIR QUALITY MANAGEMENT SYSTEM AND CONTROL THEREFOR

(71) Applicant: Broan-NuTone LLC, Hartford, WI (US)

(72) Inventors: Richard R. Sinur, Hartford, WI (US); Seddik Rougab, Hartford, WI (US); Jason Asmus, Hartford, WI (US); Loic Ares, Hartford, WI (US); Ryan Revers, Hartford, WI (US); Jim Bohn, Hartford, WI (US)

(21) Appl. No.: 17/336,203

(22) Filed: Jun. 1, 2021

(51) Int. Cl. F24F 7/003; F24F 7/00; F24F 7/007; F24F 8/00; F24F 11/00; F24F 11/49; F24F 11/50; F24F 11/62

(52) U.S. Cl. CPC F24F 7/003; F24F 7/00; F24F 7/007; F24F 8/00; F24F 11/0001; F24F 11/49; F24F 11/50; F24F 11/62; F24F 2007/001; F24F 2110/50

(57) ABSTRACT

According to an aspect of the present disclosure, an air quality management system may include a mobile application distributed to at least one user device, at least one air quality management device, and at least one computing resource, wherein the at least one computing resource operates a first networking layer configured to receive input from the at least one mobile application. Also, the at least one computing resource operates a second networking layer that receives input from the at least one air quality management device. The air quality management system may further comprise a data connection between the first and second networking layers to transfer commands of the at least one mobile application from the first networking layer to the second networking layer, and to transfer device information of the at least one air quality management device from the second networking layer to the first networking layer.

### CROSS REFERENCE TO RELATED APPLICATIONS

U.S. Provisional Patent Application No. 62/962,710 filed Jan. 17, 2020; PCT Application No. PCT/US21/12661 filed on Jan. 8, 2021; PCT Application No. PCT/US20/12487, filed on Jan. 7, 2020; U.S. Provisional Application No. 62/789,501, filed on Jan. 7, 2019; PCT Patent Application No. PCT/US19/63581, filed on Nov. 27, 2019; U.S. patent application Ser. No. 16/243,056, filed on Jan. 8, 2019; U.S. patent application Ser. No. 16/242,498, filed on Jan. 8, 2019; U.S. patent application Ser. No. 15/081,488, filed on Mar. 25, 2016; U.S. patent application Ser. No. 14/593,883, filed on Jan. 9, 2015; U.S. Pat. No. 9,297,540, filed on Aug. 5, 2013; U.S. Pat. No. 10,054,127, filed on Sep. 29, 2017; U.S. Pat. No. 9,816,724, filed on Jan. 29, 2015; U.S. Pat. No. 9,816,699, filed on Sep. 2, 2015; U.S. Pat. No. 9,638,432, filed on Aug. 31, 2010; U.S. Pat. No. 8,100,746, filed on Jan. 4, 2006; and WO 2015/168243, filed on Nov. 5, 2015, are hereby incorporated in their entirety herein by reference and made a part hereof.

### TECHNICAL FIELD

The present subject matter relates to control systems for air quality management, and more particularly, to control of devices through a mobile application.

### BACKGROUND

Often times, challenges exist for customizing and establishing air quality management systems. Conventional ventilation systems for home ventilation include ducting connected between a port to outside air (i.e., inlet port) and a fan unit. The quantity of outside air supplied into the ventilation system may be regulated to comply with applicable standards/codes, such as the American Society of Heating, Refrigeration, and Air Conditioning Engineers (ASHRAE) ventilation requirements and/or applicable building code ventilation requirements. Some models of ventilation systems may be connected to a humidity sensor, located either outside or inside of a home or other building, and/or a temperature sensor located outside of the home. The use of humidity sensor(s) and temperature sensor(s) typically requires wiring between a controller and the sensors.

If a humidity sensor is located in the home, the controller of the typical ventilation system, or a supply fan unit thereof, prevents ventilation when the inside humidity level (i.e., within the home) is undesirably high. Limiting ventilation may increase the risk of and/or quantity of pollutants being retained within the home being serviced. The locations of the temperature sensor(s) for ventilation systems must be carefully chosen to prevent outside conditions from influencing and/or altering the readings of the temperature sensor(s). Temperature sensor(s) limit and/or reduce ventilation if the accuracy of one or more temperature sensor(s) is compromised by placement and/or outside temperatures that are unusually cold or hot. Temperature and humidity sensors located within a supply duct require activation of the ventilation systems or air heat/energy recovery ventilators, in order to expose the sensor(s) to outdoor air and assess outdoor air conditions. Such recurring scheduled activation represents a significant energy expense just to gather outdoor air conditions and could also be undesirable for users. In view of these challenges a control system for creating and customizing an air quality management system throughout a structure, and with mobile device and cloud-based control, represents an improvement over conventional systems and components.

The description provided in the background section should not be assumed to be prior art merely because it is mentioned in or associated with the background section. The background section may include information that describes one or more aspects of the subject technology.

### SUMMARY

According to an aspect of the present disclosure, an air quality management system, includes a mobile application distributed to at least one user device, at least one air quality management device, and at least one computing resource wherein the at least one computing resource operates a first networking layer configured to receive input from the at least one mobile application, and wherein the at least one computing resource operates a second networking layer that receives input from the at least one air quality management device. The air quality management system further includes a data connection between the first and second networking layers to transfer commands of the at least one mobile application from the first networking layer to the second networking layer, and to transfer device information of the at least one air quality management device from the second networking layer to the first networking layer.

The air quality management system according to this aspect may further be configured such that the computing resource is a server.

The air quality management system according to this aspect may further be configured such that the first networking layer and the second networking layer are distributed across more than one server.

The air quality management system according to this aspect may further be configured such that the first networking layer and the second networking layer are implemented locally.

The air quality management system according to this aspect may further include a product information management system that supplies product specifications to the first and second networking layers.

The air quality management system according to this aspect may further be configured such that the plurality of air quality management devices comprises at least one sensor and at least one ventilation device, and wherein each sensor is linked to at least one ventilation device to control operation thereof.

The air quality management system according to this aspect may further be configured such that the at least one air quality management device is a plurality of air quality management devices arranged according to a hierarchy configured to determine device states.

The air quality management system according to this aspect may further be configured such that the plurality of air quality management devices comprises at least one sensor and at least one ventilation device, and wherein each sensor is linked to at least one ventilation device to control operation thereof.

The air quality management system according to this aspect may further be configured such that the plurality of air quality management devices comprises at least one sensor and at least one fresh air system device, and wherein each sensor is linked to at least one ventilation device to control operation thereof.

According to another aspect of the present disclosure, a method of operating an air quality management system includes developing a profile of the air quality management system, wherein the profile comprises profile data and profile data comprises identification of a number of air quality management devices, a relative location for the number of air quality management devices, and a location for the air quality management system, establishing a first user and a second user, and transferring control of the air quality management system profile from the first user to the second user.

The method of operating the air quality management system according to this aspect may further be performed such that a mobile application of the air quality management system prompts the first user to conduct the profile developing step.

The method of operating the air quality management system according to this aspect may further be performed to include transferring exclusive control of the air quality management system profile from the first user to the second user.

The method of operating the air quality management system according to this aspect may further be performed to include transferring guest control of air quality management system profile from the first user to the second user.

The method of operating the air quality management system according to this aspect may further be performed such that the profile data is used to develop a device hierarchy for the number of air quality management devices.

The method of operating the air quality management system according to this aspect may further be performed such that the device hierarchy controls a subset of the air quality management devices in response to a current state of another subset of the air quality management devices.

According to another aspect of the present disclosure, a control system for managing at least one air quality management device includes a mobile application operable by at least one user via a user interface, a first networking layer that facilitates the mobile application, a second networking layer that implements a network between the at least one air quality management device, and a communications link between the first networking layer and the second networking layer wherein the second networking layer implements operational control of the at least one air quality management device based on information prompted from the at least one user via the user interface.

The control system for managing at least one air quality management device according to this aspect may further be configured such that the mobile application prompts the at least one user via the user interface to provide identification of the at least one air quality management device, and a relative location of the at least one air quality management device.

The control system for managing at least one air quality management device according to this aspect may further be configured such that the at least one air quality management device comprises a plurality of air quality management devices wherein the second networking layer establishes a device hierarchy for implementing operational control of the plurality of air quality management devices.

The control system for managing at least one air quality management device according to this aspect may further be configured such that the device hierarchy is partly based on the relative location of the plurality of air quality management devices.

According to another aspect of the present disclosure, an information management network for air quality management includes device specifications for a plurality of air quality management devices, a first networking layer for implementing a mobile application, a second networking layer for implementing a control system for a structure, a subset of the plurality of air quality management devices associated with the structure, and a network communications link between the information management network and the first and second networking layers, wherein the first and second networking layers query the information management network for device specifications.

The information management network according to this aspect may further be configured such that user selections executed in the mobile application and control commands, communicated between the control system and at least one of the subset of the air quality management devices, are developed based on device specifications communicated via the information management network.

The information management network according to this aspect may further be configured such that the information management network supplies device specifications to the first networking layer to develop a list of air quality management devices, and a mobile application communicatively coupled with the first networking layer is configured to present to a user the list of air quality management devices.

The information management network according to this aspect may further be configured such that the information management network supplies device specifications to the second networking layer to facilitate identification of the subset of the plurality of air quality management devices associated with a structure.

The information management network according to this aspect may further be configured such that the device specifications supplied to the second networking layer are used to provide operational limits for customizing control commands to at least one of the subset of air quality management devices associated with the structure.

According to another aspect of the present disclosure, an air quality management system includes at least one air quality management device, at least one server wherein the at least one server operates a first networking layer configured to receive input from at least one user device, and further wherein the at least one server operates a second networking layer that receives input from the at least one air quality management device. Also, according to this aspect, the air quality management system may include a data connection between the first and second networking layers to transfer information from the at least one user device from the first networking layer to the second networking layer, wherein the at least one air quality management device is assigned one or more link to one of a plurality of air quality management devices identified by the second networking layer.

The air quality management system according to this aspect may further be configured such that the at least one air quality management device is a ventilation fan.

The air quality management system according to this aspect may further be configured such that the plurality of air quality management devices comprises at least one sensor that is linked to the at least one air quality management device.

The air quality management system according to this aspect may further be configured such that the linked one of the plurality of air quality management devices comprises at least one wall switch that is linked to the at least one air quality management device.

According to yet another aspect of the present disclosure, a method of operating at least one air quality management device includes steps of identifying an air quality measurement, setting an air quality measurement threshold, monitoring an air quality measurement, comparing the monitored air quality measurement to the air quality measurement threshold, maintaining a hysteresis value for the comparing step, wherein an amount of time during which the comparing step results in the monitored air quality measurement exceeding the air quality measurement threshold is cumulated during a preselected time period, and establishing a hysteresis threshold for evaluating the hysteresis value via comparison.

The method of operating at least one air quality management device according to this aspect may further be performed such that the air quality measurement threshold is adjusted in response to the comparison of the hysteresis value to the hysteresis threshold.

The method of operating at least one air quality management device according to this aspect may further be performed such that the hysteresis value is an exponential average.

The method of operating at least one air quality management device according to this aspect may further be performed such that sensitivity of one or more sensors associated with the air quality measurement threshold is adjusted in response to the comparison of the hysteresis value to the hysteresis threshold.

The method of operating at least one air quality management device according to this aspect may further be performed such that the monitored air quality measurement is humidity, and wherein the comparison of the monitored air quality measurement to the air quality measurement threshold and the comparison of the hysteresis value to the hysteresis threshold indicates a secondary attribute of indoor air quality.

Other aspects and advantages of the present invention will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a diagram of an example architecture for an air quality management system and method;

FIG. 2 is another diagram of an example architecture for the air quality management system of FIG. 1;

FIG. 3 is a diagram illustrating a product information management system interconnecting with components of the air quality management system;

FIG. 4 is a flowchart detailing a device onboarding process for adding a device to the managed ecosystem;

FIG. 5 is a flowchart detailing whole ecosystem synchronization and linking of associated air quality management devices, e.g., linking of fans with air quality monitoring sensors;

FIGS. 6A-6C depict a number of user interface configurations for adding a device to the managed ecosystem;

FIGS. 7A-7C depict a number of user interface configurations for adding a user and transferring control of the air quality management system from a one user to another;

FIG. 8 is a flowchart detailing operation of an indoor air quality function;

FIG. 9A is a flowchart detailing operation of an exemplary air quality control function for an air quality management device, specifically, a bath fan switch;

FIG. 9B is a flowchart detailing operation of an exemplary threshold adjustment function for an air quality management device, specifically, a humidity threshold for a bath fan device;

FIG. 10 is a flowchart detailing operation of a function that updates a state of an exemplary air quality management device.

FIG. 11 is a flowchart detailing operation of an exemplary air quality control function for another air quality management device, specifically, an air quality sensor disposed within a bathroom;

FIG. 12 is a flowchart detailing operation of an air quality monitoring function;

FIGS. 13A and 13B depicts a number of user interface configurations for facilitating user interaction with the indoor air quality function of FIG. 8;

FIGS. 14A and 14B depict a number of user interface configurations for facilitating user interaction with historical data for an exemplary air quality value;

FIGS. 15A and 15B depict a number of user interface configurations for facilitating user interaction with historical data for another exemplary air quality value;

FIGS. 16A and 16B depict a number of user interface configurations for facilitating user interaction with historical data for another exemplary air quality value;

FIGS. 17A and 17B depict a number of user interface configurations for facilitating user interaction with historical data for another exemplary air quality value;

FIGS. 18A and 18B depict a number of user interface configurations for facilitating user interaction with historical data for another exemplary air quality value; and

FIG. 19 is a flowchart detailing a function of the air quality management system that implements conformity with ASHRAE code whole-house ventilation requirements.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

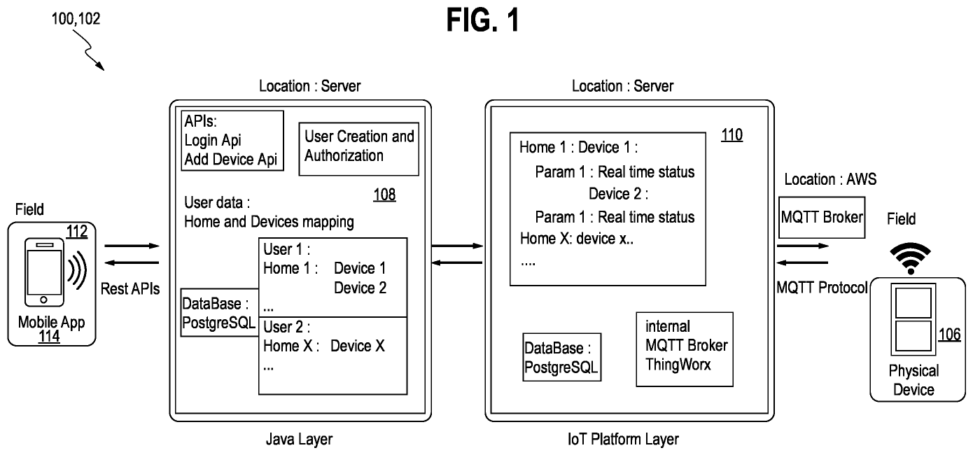

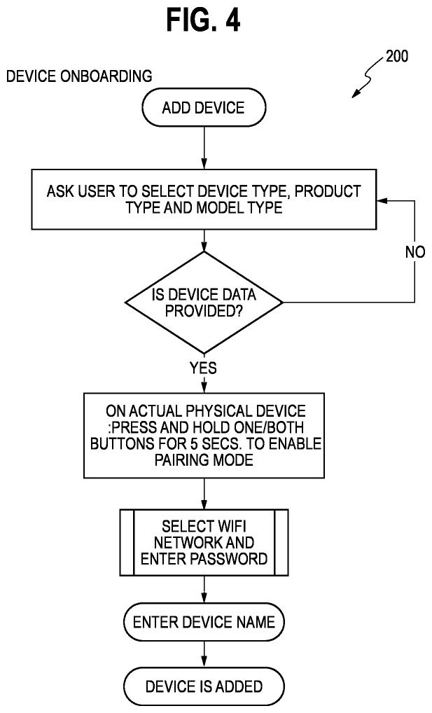

Generally, the present disclosure details, with reference to FIGS. 1-20, an air quality management system and method 100, 102 for implementing control of an air quality management ecosystem 104. The present disclosure contemplates arrangement of one or more air quality management devices 106 within the air quality management ecosystem 104, as shown in FIGS. 1-3. The air quality management devices 106 may include ventilation devices, sensors, and/or fresh air system devices. The system and method 100, 102 for implementing control of the air quality management ecosystem 104 comprises a number of functions (i.e., algorithms, see FIGS. 4, 5, 8-12, and 19).

FIG. 1 is a diagram of an example architecture for the air quality management system 100. The air quality management system 100 comprises the one or more air quality management devices 106 within the air quality management ecosystem 104. The air quality management system 100 further comprises first and second networking layers 108, 110. The first networking layer 108 is in communication with one or more user devices 112 and the second networking layer 110. The second networking layer 110 is in communication with the first networking layer 108 and the one or more air quality management devices 106. The first and second networking layers 108, 110 may be cloud-based or otherwise operate on remote computing resources, such as one or more servers, accessible to the air quality management devices 106 and the one or more user devices 112 via one or more network connections. For example, communicative links between components of the air quality management system 100 may be established via a cellular network, a local area network (LAN), a wide area network (WAN), an intranet, one or more Bluetooth® connections, one or more Zigbee® connections, and/or other suitable wireless and/or wired connections implemented by one or more communications protocols.

The first and second networking layers 108, 110 of the air quality management system 100 provide underlying computational support to the one or more user devices 112 and the one or more air quality management devices 106, respectively. In an example embodiment, the first networking layer 108 may store in memory, access, and execute programming to maintain application programming interfaces (API) for operating a mobile application 114 and user interface 116 instantiated on the one or more user devices 112. The first networking layer 108 facilitates creation of user profiles, user authorization, collection and storage of user information, collection and storage of user inputs, such as device queries, device instructions, and location information. Additionally, the first networking layer 108 may operate to prompt user input of information regarding the air quality management ecosystem 104 for a particular application of the air quality management system 100. Additionally, the first networking layer 108 may store information associating particular ones of the air quality management devices 106 with the one or more air quality management ecosystems 104. For example, in FIG. 1, the one or more air quality management ecosystems 104 are homes (e.g., “Home 1”), although the air quality management system 100 may be configured to manage varying types of structures, such as homes, offices, industrial buildings, hotels, apartment complexes, hospitals, and/or other suitable structures calling for air quality management and having associated therewith at least one of the one or more air quality management devices 106. Also, in the exemplary embodiment of FIG. 1, certain of the air quality management devices 106 may be associated with a first home, a second home, etc.

The second networking layer 110 may store in memory, access, and execute programming to maintain application programming interfaces (API) for operating and communicating with the one or more air quality management devices 106 disposed within, or otherwise associated with, the one or more air quality management ecosystems 104. For example, in FIG. 1, the second networking layer 110 monitors the air quality management devices 106 for changes in device status, operation, and/or air quality measurements gathered thereby. A number of suitable communications and control protocols (or Internet of Things Platforms) may be utilized by the second networking layer to monitor and direct the air quality management devices 106, including Thinkworx®, MQTT™ (Message Queuing Telemetry Transport), Bluetooth®, Zigbee®, WiFi®, and/or other application specific protocols. One or more databases may be incorporated in or accessible to the second networking layer 110 for storage and organization of air quality measurements, device information (IP address, user inputs to devices, etc.), real-time device statuses, and/or user inputs to the devices 106 (e.g., user actuating a switch). The first and second networking layers 108, 110 exchange information regarding user inputs/directives, air quality measurements, device configuration, and other information, as desired. For example, the air quality management devices 104 present within an air quality management ecosystem 104 may be identified by the second networking layer 110, which, in turn, provides information/data from the air quality management devices 104 to the one or more user devices 112. In such an exemplary embodiment, the one or more air quality management devices 106 detected by the second networking layer 110 may be presented to a user along with a list of rooms within a structure. In turn, a user may associate one or more air quality management devices 106 with one or more rooms of the structure to establish and parameterize the air quality management ecosystem 104. The air quality management ecosystem 104 comprises, among other components, the structure wherein the air quality is managed and the air quality management devices 106 disposed within that structure.

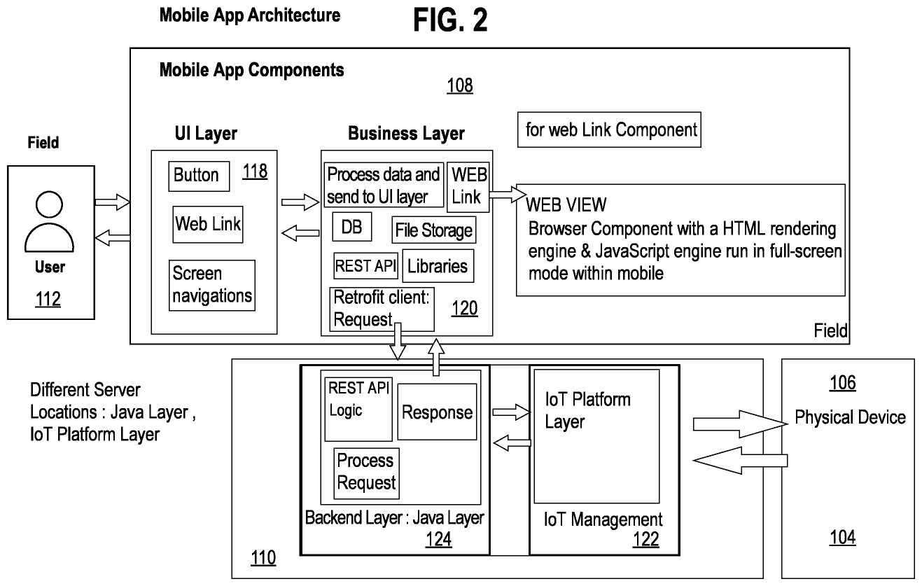

Referring now to FIG. 2, an example architecture for the air quality management system 100 is shown. In this example architecture, the first networking layer 108 further comprises a user interface layer 118 and a business layer 120. The user interface layer 118 renders screen navigation and virtual button aspects of the user interface 116 that are displayed on the user device 112 and interacted with by a user. The second networking layer 110 further comprises an IoT (internet of things) layer 122 and a processing layer 124. The processing layers 124 facilitates communications with the business layer 120 of the first networking layer 108. The IoT layer 122 communicates and detects the one or more air quality management devices 106. Additionally, the IoT layer 122 may coordinate control commands and other operations of the air quality management devices 106.

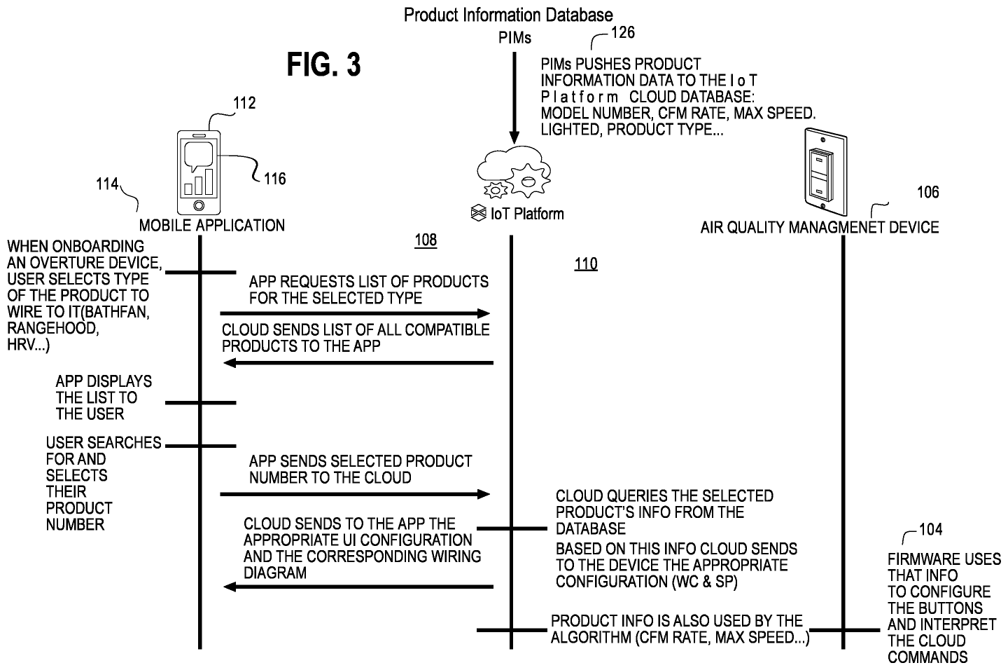

In the exemplary embodiment of FIG. 3 a product information management system (PIMS) 126 interconnects with components of the air quality management system 100 to supply product specification information to the first and/or second networking layer 108, 110. When the user interface 116 of the mobile application 114 is utilized to establish the air quality management ecosystem 104, a user may request through the user interface 116 a category of devices (e.g., bathroom fans). The first or second networking layer 108, 110 relays the device category request to the PIMS 126, and the PIMS 126 returns a list of products compatible with the air quality management system 100. The product list is displayed by the user interface 116 for selection of a desired device by a user. Upon entry of the selection, such as by a virtual button press, the mobile application 114 communicates product identification information for the selected air quality management device to the first networking layer 108. In response to the selection, the PIMS 126 communicates detailed product/device specifications to the second networking layer 110. Alternatively, if a product is not identified in the list, then “other” may be selected and product specifications may be input by a user. Based on the detailed product specifications, the second networking layer 110 is able to appropriately address the selected one of the air quality management devices 106. As a result, firmware of the selected device is updated and/or appropriately configured based on the detailed product specifications. The detailed product specifications are also stored within a database in the second networking layer 110 for quick and efficient access by the processing layer 124 (see FIG. 2).

A device onboarding function/process 200 is shown in FIG. 4. The device onboarding function/process 200 includes an initial step of requesting that a user select an air quality management device type, product type, and model type. These identifiers may be searchable, provided as a list, such as through a drop-down menu, or be selectable in another suitable manner. As previously noted, the PIMS 126 may provide product identifiers for use in the mobile application 114, amongst other uses within the air quality management system 100. If an onboarding device is correctly identifiable via the user interface 116, then an interaction with the selected air quality management device may initiate pairing. For example, some of the air quality management devices 106 may be placed in a pairing mode by via a button “press and hold”. Once paired, the air quality management device 106 may be assigned a name and connected to a local network, such as a WiFi® network servicing the air quality management system 100.

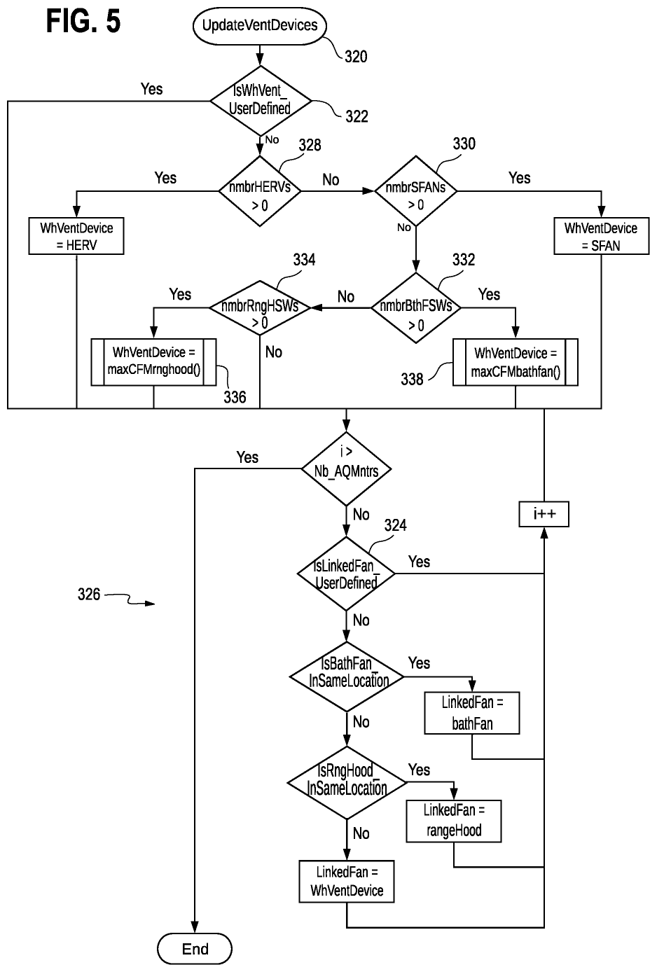

FIG. 5 is a flowchart detailing whole ecosystem synchronization and linking of associated air quality management devices, e.g., linking of fans with air quality monitoring sensors. The ventilation update function/process 320 begins by observing, at decision step 322, whether a user has defined a whole house ventilation device via the mobile application 114. If yes, then the ventilation update process 320 progresses to a device linking block. If an incremental counter is less than a total number of air quality sensors, then fan linking is undertaken whereby a next air quality sensor is associated with a fan/ventilation air quality management device. Accordingly, process 320 iterates through each of the available air quality sensors to check for fan linking. At step 324, the ventilation update process 320 checks whether a user has defined the fan to link with an air quality sensor for which the ventilation update process 320 is being executed. In functional block 326, the ventilation update process 320 checks the availability of certain ventilation devices within the air quality management ecosystem 104. Specifically, a device hierarchy is developed to select a ventilation device to designate as the whole house ventilation device. At step 328, presence of a heat/energy recovery ventilation (HERV) device is checked. The HERV device, if present, becomes the default whole house ventilation device. However, if no HERV devices are present, then the ventilation update process 320 proceeds to step 330 to check for the presence of a supply fan. Again, if a supply fan is present it is assigned as the ventilation device for the house ventilation. If neither a HERV device nor a supply fan are present, then the ventilation update process 320 progresses to a bathroom fan check at step 332. In the checking step 332, the ventilation update process 320 observes whether a bath fan device is available. If a bath fan device is present, then it is assigned as the whole house ventilation device at step 338. However, if none of the previously checked ventilation devices are present, then the ventilation update process 320 checks for a range hood device at step 334. If a range hood device is the only available ventilation device, then it is assigned as the whole house ventilation device at step 336. When only range hood devices and bath fan devices are available for assignment as the whole house ventilation device, then a selection may be made based on which device is capable of producing a higher maximum cubic feet per minute (CFM) rate of air flow/ventilation. In functional block 326, location information for assigned ventilation devices is checked against the locations of the air quality monitoring sensors.

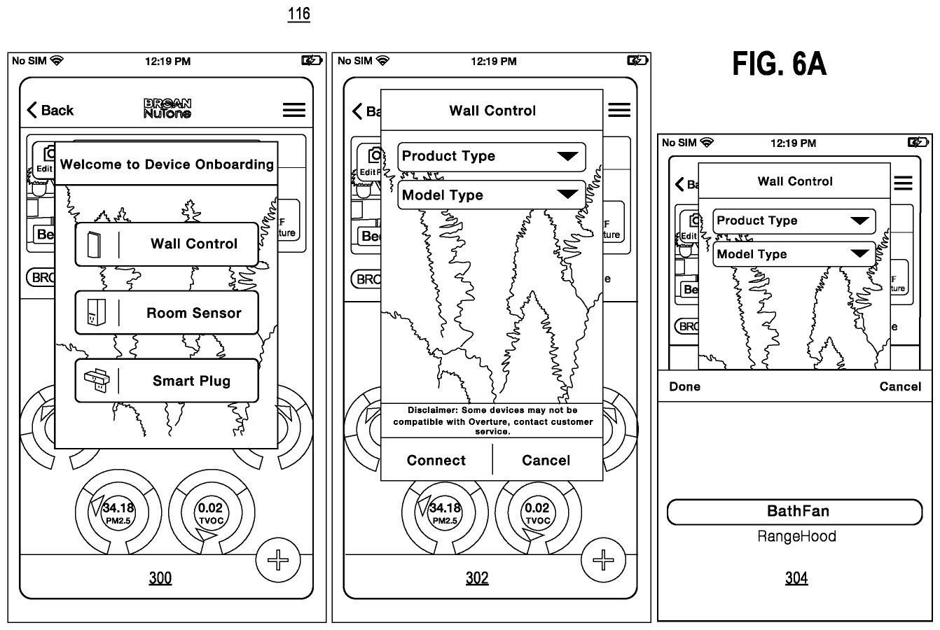

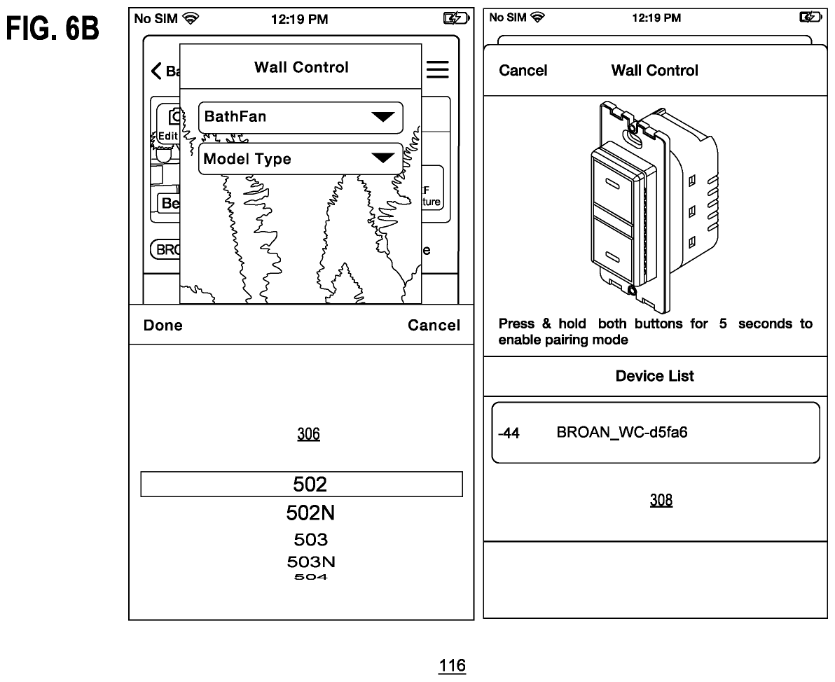

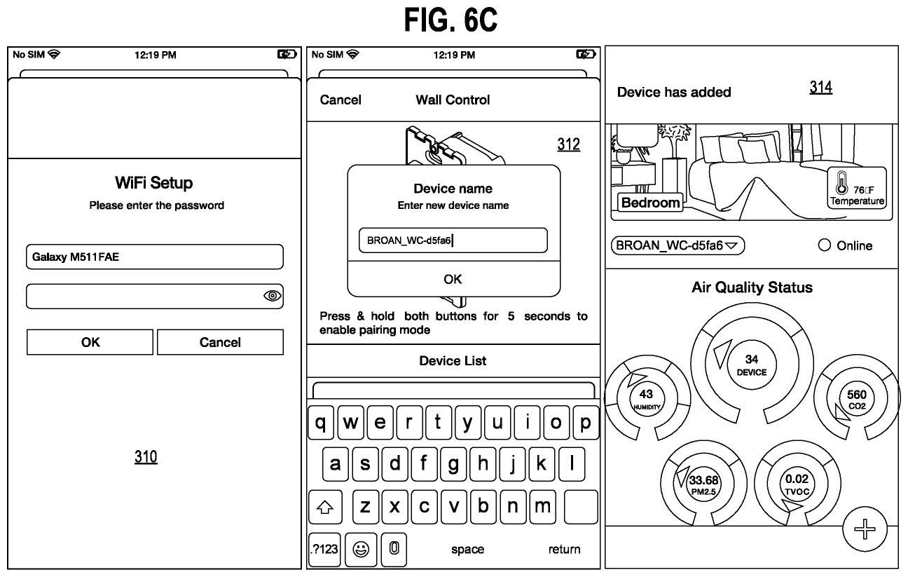

FIGS. 6A-6C depict a number of user interface configurations for adding a device to the managed ecosystem. The user interface configurations of FIGS. 6A-6C correspond to certain steps of the device onboarding function 200 (FIG. 4). In user interface configuration 300, a device type is selected for onboarding from categories: wall control, room sensor, smart plug, etc. Additional sensor driven devices may also be available for selection. Alternatively, “other” may be an available option, which prompts a user to input information regarding a device for inclusion in the managed ecosystem. In user interface configuration 302, a product type and model type are selected for the device type selected in the previous user interface configuration 300. User interface configuration 304 illustrates an exemplary selection of “BathFan” as the desired product type, and user interface configuration 306 in FIG. 6B shows selection of “502” as a model type. A pairing operation is instructed via a user interface configuration 308 displaying a message to a user regarding a button “press and hold” operation. In user interface configuration 310, a WiFi® network connection is set for the now paired air quality management device 100, and the air quality management device 100 is assigned a user-supplied name via user interface configuration 312. User interface configuration 314 displays a confirmation message regarding completion of the device onboarding process 200.

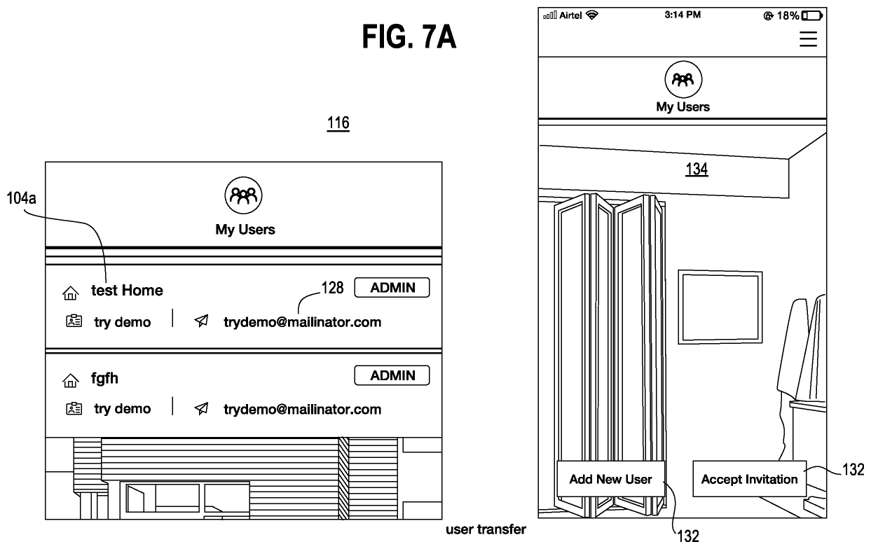

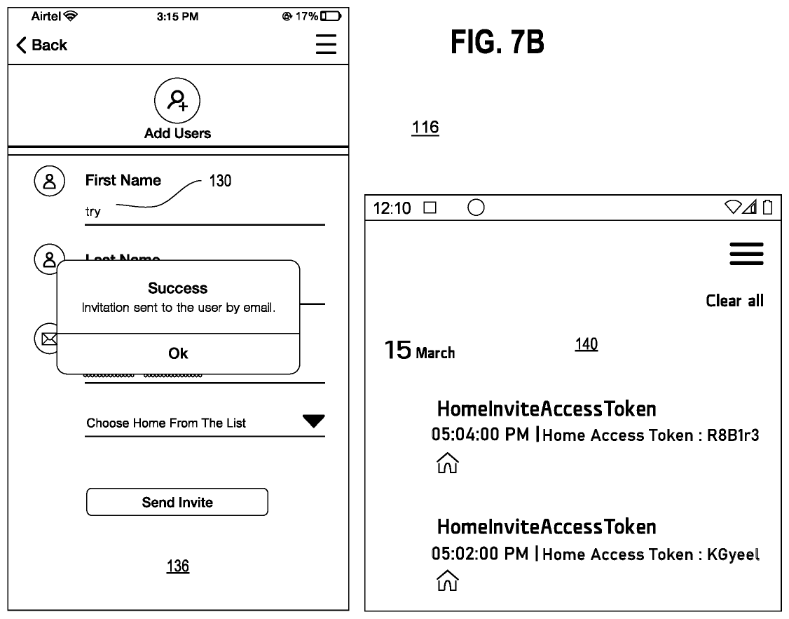

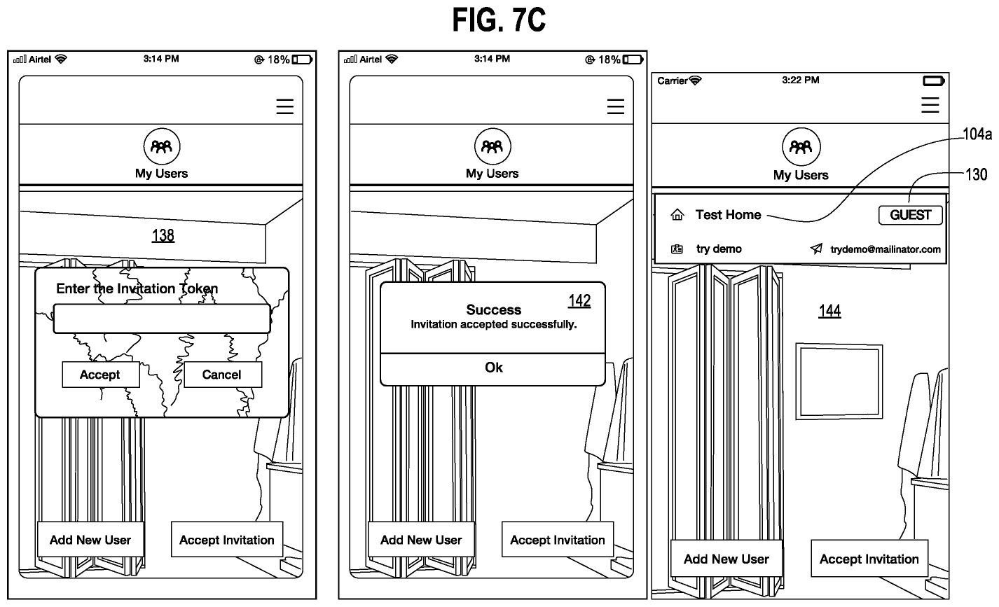

The air quality management system 100 may be associated with one or more users possessing the one or more user devices 112. A plurality of users may have access to the mobile application 114 to exert control over the air quality management system 100. However, it is desirable in certain circumstances to transfer control of the air quality management system 100 from a first user 128 to a second user 130. FIGS. 7A-7C depict a number of user interface configurations for granting secure access to a subsequent user and transferring control of the air quality management system 100 from the first user 128 to the second user 130. Once the air quality management ecosystem 104 has been established (see FIGS. 4A and 4B), the first user 128 may select the established ecosystem for transfer. In the embodiment of FIG. 7A, an example air quality management ecosystem 104a is assigned the name “test home”. The “test home” 104a may be selected by the first user 128, via triggering of virtual button 132 labelled “Add New User”, for transfer to the second user 130. User interface configuration 134 displays the “Add New User” virtual button 132 and an “Accept Invitation” virtual button 132. In response to triggering of the “Add New User” virtual button 132, the first user 128 is given notification of the successfully sent invitation via user interface configuration 136. In another instantiation of the mobile application 114, the second user 130 may be presented with a notification, virtual button, and/or another suitable indicator of the invitation transmitted by the first user 128. In the notification, the second user 130 may be prompted to accept or deny the transfer request. In the example of FIG. 7B, the second user 130 is presented with a secure invitation token 140 for purposes of identification and verification during transfer of control the “test home” 104a. In user interface configuration 138, the second user 130 enters the secure invitation token 140. Following receipt and verification of the secure invitation token 140 by the first networking layer 108. The second user is notified of acceptance of the secure invitation token 140 via notification user interface configuration 142. Once the secure invitation token 140 is verified, the second user 130 is presented with a user interface configuration 144 wherein the “test home” ecosystem 104a is available for control, by the second user 130, via the mobile application 114.

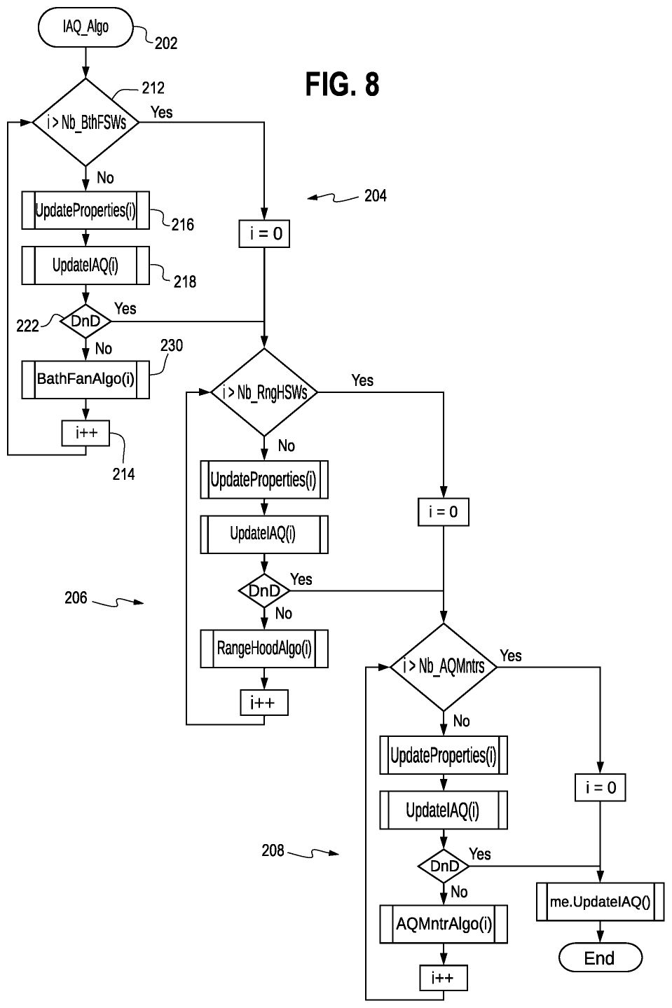

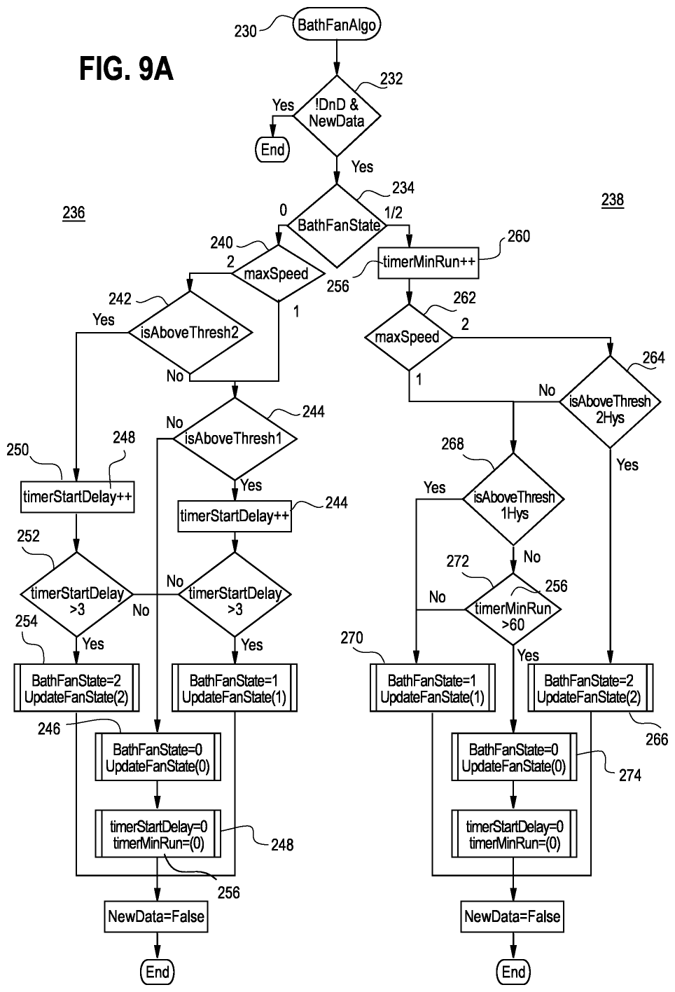

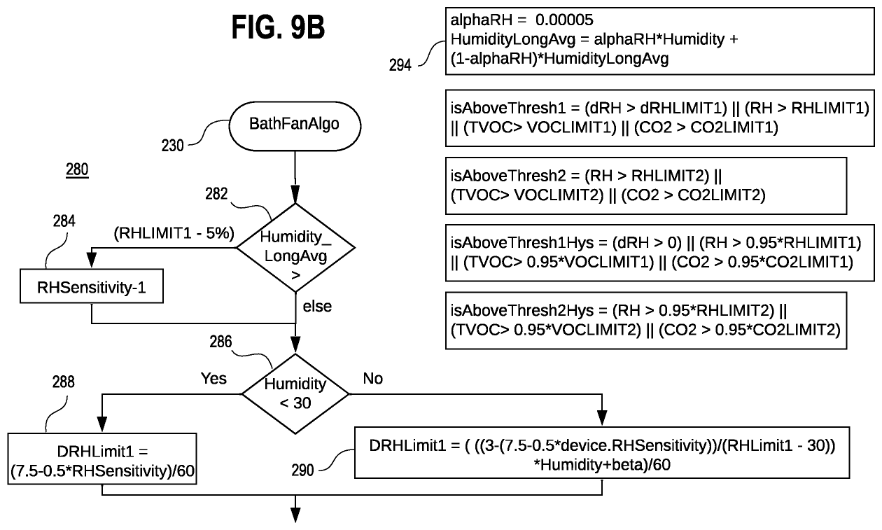

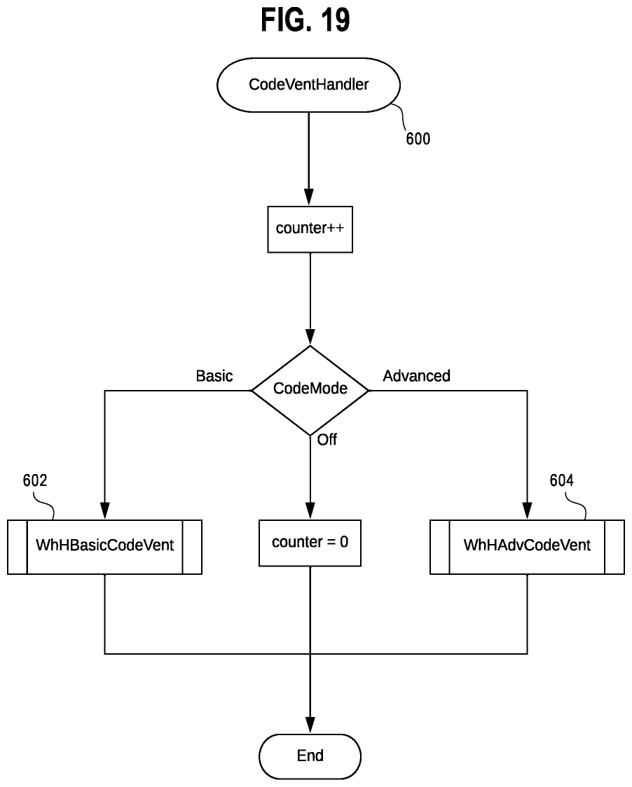

The air quality management system 100 operates the one or more air quality management devices 106 to monitor air quality, maintain air quality, and comply with air circulation and quality requirements of one or more building codes or residential/commercial building ventilation standards, e.g., ASHRAE 62.2/62.1, Canada Standards Association (CSA) F326—Residential Mechanical Ventilation Systems, International Energy Conservation Code® (IECC), ANSI/ASHRAE/IESNA Standard 90.1, etc. The goal of the air quality management system 100 operating to comply with a standard may be to meet ventilation/airflow standards or to maintain an air quality such that indoor air pollutants are below recommended levels. FIG. 8 is a flowchart detailing operation of an indoor air quality function that operates to meet air quality standards (such as by operating in accordance with a code ventilation function/process shown in FIG. 19) or implement instructions of a user controlling the air quality management ecosystem 104. In FIG. 8, an air quality function 202 is detailed. The air quality function 202 implements whole-house ventilation requirements, and updates number, sensor data, and identification of the one or more air quality management devices 106 present within the air quality management ecosystem 104. In exemplary embodiments, the air quality function 202 is executed in parallel with certain other processes such as a code ventilation function/process shown in FIG. 19, a bath fan control function/process shown in FIG. 9A, and/or other functions/processes called by the air quality function 202 or simultaneously by the air quality management system 100. For example, the air quality function 202 may query the air quality management devices 106 for air quality measurement values and identification of the air quality management devices 104. The air quality function 202 may be called frequently within operation of the air quality management system 100, e.g., every 10 seconds. The air quality management function 202 comprises three function blocks/processes: a bath fan function block 204, a range hood function block 206, and an air quality sensor function block 208. More or fewer function blocks and/or function blocks corresponding to varying categories of the one or more air quality management devices 106 may be included in the air quality management function 202 depending upon the size and device profile of the air quality management ecosystem 104 being controlled.

The air quality management function 202 enters the bath fan function block 204 and checks, at decision step 212, whether an incremental counter 214 is greater than a number of bath fans present amongst the air quality management devices 106 in the presently controlled air quality management ecosystem 104. If the number of bath fans is greater than the incremental counter 214 than this function executes steps 216, 218 wherein sensor update functions are called, which updates sensor information received from the current bath fan (identified by the incremental counter, i.e., bath fan (i)). Accordingly, the bath fan function block 204 is executed for each bath fan device presently controlled by the air quality management ecosystem 104. Following the sensor update function 218, an update function updates the air quality function 202 by assigning the current bath fan a new air quality score. At step 222, the air quality function 202 checks whether the current bath fan is presently in a “do not disturb” mode. The “do not disturb” mode may affect the capabilities of the air quality management device 106 and limit the ability of the air quality management system 100 to rely on those capabilities. For example, when one of the air quality management devices 106 is in “do not disturb” mode, it may have been disabled by a user, such as through the mobile application, or by a technician, such as for maintenance. Safety features, such as detected electrical faults, duct/fan blockages, social gatherings, desired decrease in mechanical noise, certain desired room uses, and/or other conditions, may result in entry of one or more of the air quality management devices 106 into a “do not disturb” mode. The “do not disturb” mode may be assigned to a single air quality management device, a category of devices (e.g., bath fans, 2^{nd} floor devices, sensors, etc.), and/or all air quality management devices of a particular ecosystem. If the incremented bath fan is not in a “do not disturb” mode, then a bath fan control function/process 230 is called to operate the bath fan in accordance with any inputs or other directives of the air quality management system 100. After the bath fan control function 230 has been called, the incremental counter 214 is incremented and the function returns to decision step 212. Once the incremental counter 214 exceeds the number of bath fans present within the example air quality management ecosystem 104, then the air quality management function 202 moves to the next functional block. In the exemplary embodiment of FIG. 8, the air quality management function 202 moves from the bath fan function block 204, to the range hood function block 206, followed by the air quality sensor function block 208. The range hood function block 206 and the air quality sensor function block 208 operate according to analogous steps to those of the bath fan function block 204.

The bath fan control function/process 230 is detailed in the flowchart of FIG. 9A. The bath fan control process 230 is an exemplary control function for operation of the air quality management devices 106. In an initial decision step 232 checks whether a particular “bath fan” device of the one or more air quality management devices 106 is in a “do not disturb” mode and whether a new data flag is false. The new data flag is true when the bath fan device has had sensor data updated in the interim between a present call of the bath fan control function 230 and a previous execution thereof. If neither of these conditions are true, then operation of the bath fan device may proceed to a bath fan state check 234. The bath fan state check 234 observes an operational state of the bath fan device. In this embodiment, “0” state indicates that the bath fan device is currently in an off state, and “1” and “2” states indicate that the bath is in an on state. If the bath fan is in an off state at the decision step 234, then the bath fan control process 230 enters a currently-off function block 236. If the bath fan is in an on state at the decision step 234, then the bath control process 230 enters a currently-on function block 238.

In the currently-off bath fan function block 236, a maximum speed capability of the bath fan device is observed at step 240. If the bath fan has a first speed and a second speed, then the function enters step 242 whereat a second conditional threshold for entry of the bath fan device into the second speed is observed. Typically, the second speed is faster than the first speed and is associated with a higher conditional threshold compared to the first speed, which would have a correspondingly lower conditional threshold. If the second conditional threshold is not met, then the bath fan process 230 proceeds to step 244 whereat a first conditional threshold for entry of the bath fan device into the first speed is observed. If the first conditional threshold is also not met, then the bath fan device state does not change (i.e., the bath fan device remains in the off state). Step 246 updates registers to indicate that the bath fan device remains in the off state and a run time variable 256 and a start delay variable 248 are re-initialized to zero.

If the second conditional threshold is met at step 242, then the bath fan process 230 updates the start delay variable 248 at increment step 250. The start delay variable 248 operates to delay a state change of the bath fan device until the conditional threshold has been surpassed for a certain length of time. In this example, timer start delay is measured in passes through the bath fan control process 230 (i.e., by incrementing the start delay variable 248 until the start delay variable 248 surpasses integer value 3. Given that the bath fan control process 230 is called by the air quality management function 202, which, in turn, is called about every ten seconds, the start delay variable surpasses the integer value “3” after about thirty seconds of a persistent air quality attribute exceeding the conditional threshold. Once the start delay variable 248 surpasses value 3 at step 252, the conditional threshold for the second speed of the bath fan device has persisted for a sufficient length of time that the bath fan device state should be updated to “2”. This feature ensures that the bath fan device is not turned on for a spike in data, but instead for the true and consistent presence of an air quality attribute that exceeds the conditional threshold. The bath fan device state is updated to “2” at step 254, and the bath fan device is directed to operate at the second speed. Before the bath fan process 230 ends, the new data flag is set to false.

In the currently-on bath fan function block 238, the fan run time variable 256 is incremented at step 260. The fan run time variable 256 tracks the length of time during which the bath fan device state is one of either “1” or “2”. Tracking run time of the bath fan device ensures that the bath fan device maintains an “on” state for a sufficient length of time to address any air quality value that exceeded one or both of the conditional thresholds. Further, this feature prevents frequent changes in the bath fan state (e.g., turning “off” and “on” repeatedly). In the currently-on bath fan function block 238, a maximum speed capability of the bath fan device is observed at step 262. If the bath fan has a first speed and a second speed, then the function enters decision step 264 whereat a second hysteresis threshold for entry of the bath fan device into the second speed is observed. The second hysteresis threshold monitors whether an air quality value is above a second conditional threshold. However, the second hysteresis threshold is updated based on settled air quality values observed within the air quality management ecosystem 104. In exemplary embodiments, a deactivation hysteresis threshold represents 95% of the activation threshold. Thus, if the activation threshold is adjusted via sensor sensitivity adjustment, then the deactivation threshold is similarly adjusted. The threshold values for the derivatives of absolute thresholds are also adjustable based on current measurements for each sensor. In exemplary embodiments, threshold values may be changed in programming (as absolute thresholds), or by adjusting the sensitivity of air quality sensors. Adjustment of sensors may result in adjustment of first and second (e.g., upper and lower) thresholds via a single sensitivity adjustment of a sensor monitoring a particular air quality attribute. Further, in examples, the derivative of certain air quality attributes is observed to monitor acute events such as operation of a shower, presence of fire, presence of smoke, and/or other air quality attributes that may change more or less rapidly depending on conditions within the managed ecosystem and outside the managed ecosystem (e.g., running a shower may change humidity quickly, but the arrival of spring may change humidity gradually). If an air quality value/attribute exceeds the second hysteresis threshold, then the bath fan process 230 proceeds to step 266 whereat the bath fan device state is updated to “2”. Alternatively, if the second hysteresis threshold is not exceeded, then the air quality value is compared to the first hysteresis threshold at decision step 268. If an air quality value exceeds the first hysteresis threshold at the decision step 268, then the bath fan process 230 proceeds to step 270 whereat the bath fan device state is updated to “1”, indicating the first speed. But, if an air quality value does not exceed the first hysteresis threshold at the decision step 268, then the bath fan process 230 checks the run time variable 256 at decision step 272. If the run time variable 256 does not yet exceed 60 (i.e., representative of 10-minute minimum run time), then the bath fan process proceeds to the bath fan device state updating step 270. However, if the run time variable 256 exceeds 60, then the bath fan device has been running for 10 minutes and an air quality value responsible for triggering the currently-on bath fan function block 238 is no longer detected. As a result, the bath fan process 230 proceeds to step 274, which updates registers to indicate that the bath fan device is being returned to the off state and the run time variable 256 and the start delay variable 248 are re-initialized to zero. Before the bath fan process 230 ends, the new data flag is set to false.

Referring now to FIG. 9B, the bath fan control function/process 230 may execute a humidity monitoring function/process 280. An average humidity check 282 compares the current humidity against a long-term average or exponential moving average. In an example, the average humidity may be determined using the current humidity and a previous average humidity value (as opposed to a running average). In determining a long-term average, older humidity measurements may be weighted differently from newer measurements (“alphaRH” is a weight variable for determining a historical average by a long-term average equation 294 in FIG. 9B). In this example, a current humidity measurement and the previous humidity average are used to calculate a new humidity average, with a greater weighting value applied to the previous humidity average. If a relative humidity is within 5% from a relative humidity limit, then the sensitivity of a humidity sensor may be decreased by 10% (or 4% or another suitable relative quantity), at register update step 284, in order to lower a humidity threshold. However, if relative humidity is greater than a historical average humidity, then humidity may be checked against a threshold limit at decision step 286. The threshold limit is 30% in the illustrated example of FIG. 9B, but such a threshold is customizable depending on the managed ecosystem. In response to comparison of the relative humidity against the humidity threshold limit, a derivative relative humidity threshold limit may be updated. The bath fan control function/process 230 may observe a derivative relative humidity to determine how quickly relative humidity is changing. For example, if relative humidity is changing very rapidly, a shower event within a bathroom may be indicated. Alternatively, if relative humidity slowly increases than outside humidity may be changing seasonally and affecting indoor humidity measurements. It is also contemplated that these two humidity measurements may be treated differently, e.g., a shower event may trigger ventilation via a bath fan device, but gradual humid increase may not trigger a ventilation event because the outside humidity is likely the cause of such an increased indoor relative humidity measurement. In examples, the derivative threshold may be adjusted to account for the current humidity level (e.g., instead of a fixed threshold for the humidity's slope/derivative, the current humidity measurements are used to adjust the derivative threshold). For example, if a current humidity level is 30%, the derivative threshold for the slope to activate an associated bath fan device may be 7.5%/minute, but if the current humidity level is 50% then the threshold is lowered to 3.75%/minute. At step 288, the derivative relative humidity threshold limit may be adjusted for a shower event or the like because humidity is less than an absolute threshold limit at step 286. Alternatively, at step 290, the derivative relative humidity threshold limit may be adjusted for a seasonal weather change or the like because humidity is higher than an absolute threshold limit at step 286.

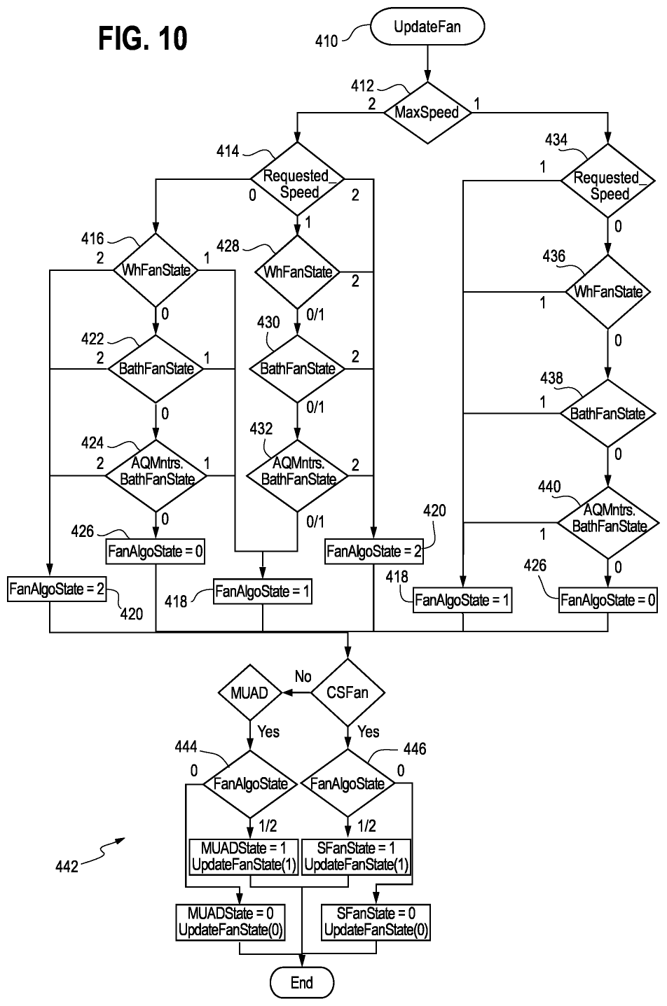

FIG. 10 is a flowchart detailing operation of an update fan function/process 410. The update fan process 410 is illustrated specifically for the bath fan device. Although analogous devices may be updated according to an analogous function, including a range hood fan, or another fan with two speeds. At decision step 412, the update fan process 410 checks for the maximum available speed for the particular one of the air quality management devices 106 to be updated, i.e., the bath fan in this example. If the bath fan device has two speeds the update fan process 410 proceeds to decision step 414. The requested speed is observed at the decision step 414. If the requested speed is “0”, i.e., then the update fan process 410 progresses to a whole house fan state check 416. If the whole house fan state check 416 is “1” or “2” then the bath fan device is also designated as the whole house fan device for the air quality management ecosystem 104, and the bath fan device is directed to enter an on state as the whole house fan device. The bath fan device state is then updated to “1” or “2” at register update step 418 or register update step 420, respectively. If the whole house fan check 416 indicates “0”, then the update fan process 410 proceeds to a bath fan state check 422. If the bath fan check 422 indicates “1” or “2” then the bath fan process 230 (see FIG. 9A) has directed the bath fan device to enter an on state. The bath fan device state is then updated to “1” or “2” at the register update step 418 or the register update step 420, respectively. If the bath fan check 422 is “0”, then the update fan process 410 proceeds to an air quality monitor check 424 for an air quality sensor that is linked/associated with the bath fan device. If the air quality monitor check 424 is “1” or “2” then an air quality sensor process has directed the bath fan device to enter an on state. The bath fan device state is then updated to “1” or “2” at the register update step 418 or the register update step 420, respectively. However, if the air quality monitor check 424 is “0” then none of the processes controlling the bath fan device state have directed the bath fan device to turn on. As a result, the bath fan device state is updated to “0” at the register update step 426.

If the requested speed observed at the decision step 414 as “1”, then the update fan process 410 proceeds to a whole house fan state check 428. If the whole house fan state check 428 is “2”, then the speed request is overridden by the whole house fan speed directive, and the bath fan device state is then updated to “2” at the register update step 420. If the whole house fan state check 428 is “0” or “1”, then the requested speed of the bath fan device is compatible with the fan state directive for the whole house fan device, and the update fan process 410 proceeds to a bath fan state check 430. If the bath fan check 430 indicates “2” then the speed request is overridden by the bath fan state speed directive, and the bath fan device state is then updated to “2” at the register update step 420. However, if bath fan check 430 indicates “0” or “1”, then the bath fan process 230 (see FIG. 9A) has directed the bath fan device to enter either of these states, and the update fan process 410 proceeds to an air quality monitor check 432. If the air quality monitor check 432 indicates “2” then the speed request is overridden by the air quality sensor process, and the fan device state is updated to “2’ at the register update step 420. Alternatively, if the air quality monitor check 432 indicates “0” or “1”, then the speed request is compatible with the air quality sensor process, and the fan device state is updated to “1” at register update step 418.

At the decision step 412, the update fan process 410 checks for the maximum available speed for the particular one of the air quality management devices 106 to be updated, i.e., still the bath fan in this example. If the bath fan device has only one speed, then the update fan process 410 proceeds to a speed request step 434 whereat a requested speed is observed. If the requested speed is “1”, then the update fan process 410 moves to the register update step 418 and the bath fan device state is set to speed “1”. However, if the request speed is “0”, then the update fan process 410 proceeds a whole house fan state check 436. If the whole house fan state check is “1”, the update fan process 410 moves to the register update step 418 and the bath fan device state is set to speed “1” in accordance with the role of the bath fan device as the whole house ventilation in this instance. Otherwise, the update fan process 410 progresses to a bath fan state check 438. If the bath fan state check 438 is “1”, the update fan process 410 moves to the register update step 418 and the bath fan device state is set to speed “1”. Otherwise, if the bath fan state check 438 is “0”, then the update fan process 410 progresses to an air quality monitor check 440 in the case that the bath fan device is associated/linked with an air quality monitor. If the air quality monitor check 440 indicates “1”, the update fan process 410 moves to the register update step 418 and the bath fan device state is set to speed “1”. Alternatively, if the air quality monitor check 440 is “0”, then the requested off state is compatible with all of the alternate role checks for the bath fan device. As a result, the bath fan device state is updated to “0” at the register update step 426.

In the functional block 442, the device states of a make-up-air device (MUAD) and a supply fan are controlled, if present within the air quality management ecosystem 104. At the fan state checks of step 444 and step 446, the bath fan device state register is polled. If the bath fan device is in or is entering an on state, then the supply fan will enter an equivalent on state to balance ventilation across the air quality management ecosystem 104. Alternatively, if no supply fan is present, then the MUAD enters an “on” state equivalent to that of the bath fan device in order to balance ventilation across the air quality management ecosystem 104.

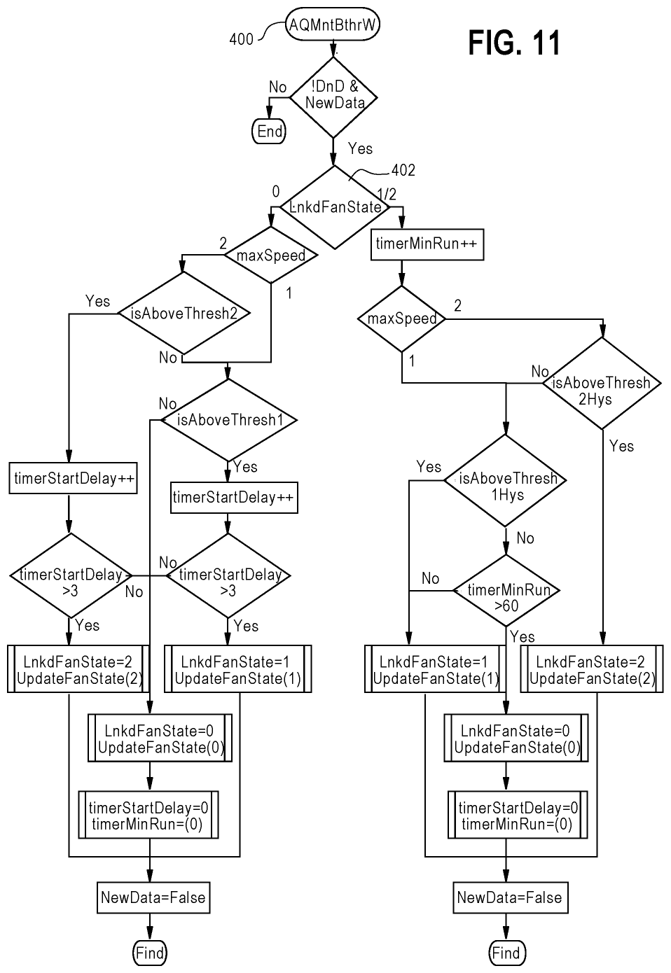

FIG. 11 is a flowchart detailing operation of an air quality sensor process/function 400 for another one of the air quality management devices 106, specifically, an air quality sensor disposed within a bathroom. The air quality sensor operated by the air quality sensor process 400 is linked to an associated fan. For example, the air quality sensor may be disposed within a bathroom and be linked to a bath fan. Alternatively, the air quality sensor may be disposed within any suitable room and be linked to a supply fan for the entire structure. Other suitable arrangements also exist with differing numbers and configurations of air quality sensors and fan devices. The functional blocks and individual steps of the air quality sensor process/function 400 are analogous to the bath fan process 230 (see FIG. 9A), however, the ventilation device addressed is different. For example, step 402 of the air quality sensor process 400 is a linked fan state check step analogous to the bath fan state check 234 of the bath fan process 230. Elsewhere in the air quality sensor process 400, a state of the linked fan is updated in a similar manner to updating of the bath fan device state in the bath fan process 230.

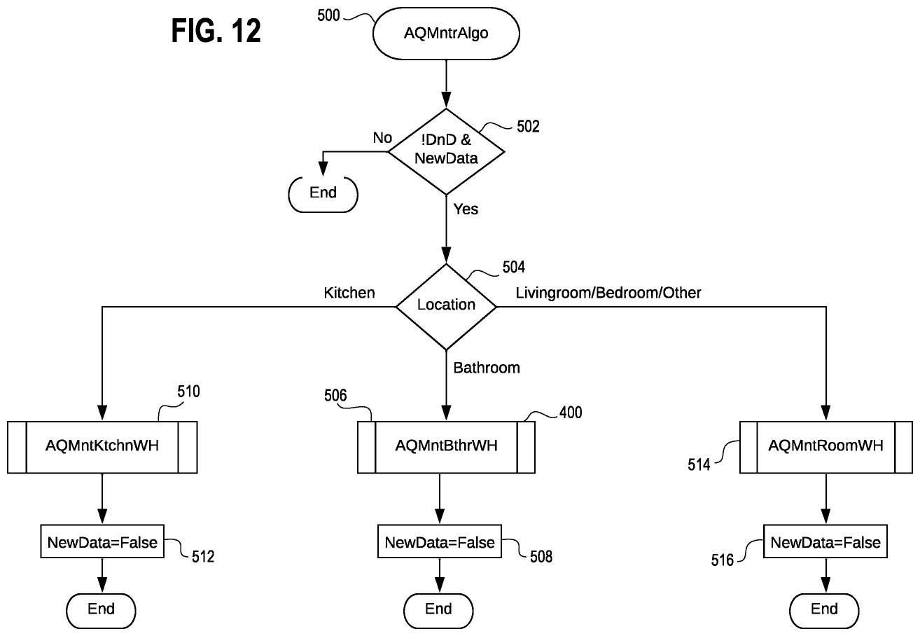

In FIG. 12 a flowchart details operation of an air quality monitoring function/process 500 for calling the air quality sensor process/function 400 or an analogous function for a different room. At step 502, the air quality monitoring process 500 checks whether one or more air quality sensors are in a “do not disturb” mode and whether a new data flag indicates new data is present from the one or more air quality sensors. If either of these conditions are indicated, then the air quality monitoring process 500 ends. However, if neither condition is present then an air quality sensor location is checked at step 504. If the air quality sensor is located within a bathroom, then the air quality monitoring process 500 proceeds to step 506 that executes the air quality sensor function 400 for a bathroom location of the sensor and associated fan and sets a new data flag to false at register update step 508. If the air quality sensor is located within a kitchen, then the air quality monitoring process 500 proceeds to step 510 that executes an air quality sensor function for a kitchen location of the sensor and associated fan (e.g., a range hood). The new data flag is set to false at register update step 512. If the air quality sensor is located within another room (e.g., a living room, bedroom, basement, attic, etc.), then the air quality monitoring process 500 proceeds to step 514, which executes an air quality sensor function for another sensor location for the sensor and associated fan (e.g., a range hood). The new data flag is set to false at register update step 516.

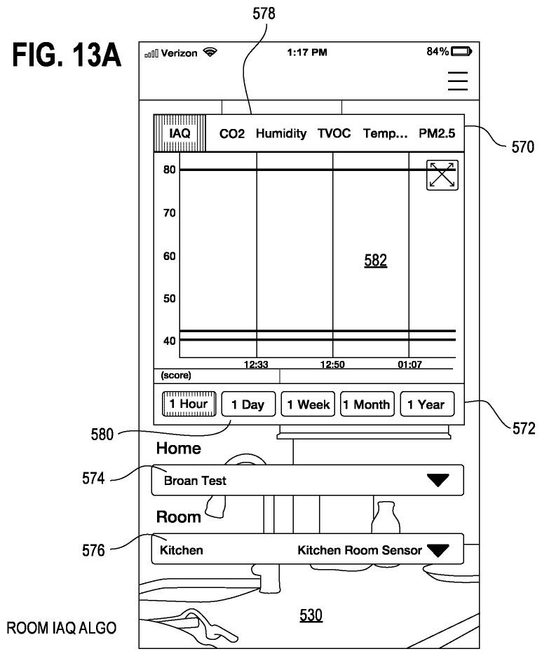

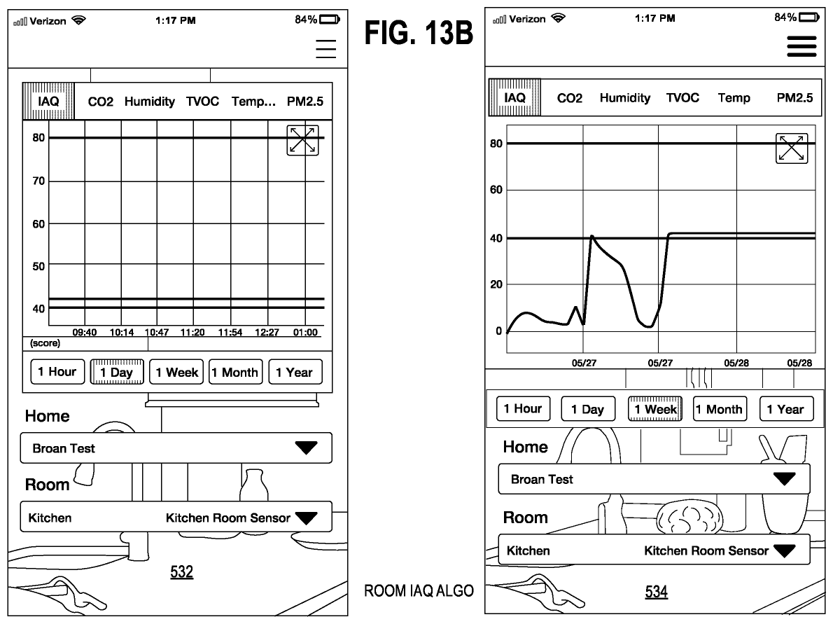

FIGS. 13A-18B depict a number of user interface configurations for facilitating user interaction with the indoor air quality function of FIG. 8. In FIGS. 13A-17B, user interface configurations 530-564 display first and second virtual button ribbons 570, 572. The user interface configurations 530-564 also display first and second drop-down lists 574, 576. The first virtual button ribbon 570 comprises a number of virtual buttons corresponding to air quality attributes 578. In the exemplary embodiment's shown in FIGS. 13A-17B, the air quality attributes 578 include a home indoor air quality index (IAQ, composite attribute), a carbon dioxide (CO2) level, a humidity level, a total volatile organic compounds (TVOC) level, a temperature, and a level of particulate matter smaller than 2.5 microns (PM2.5). Not all of the virtual buttons corresponding to these listed attributes may be displayed at the same time. In certain instances, a user may have the capability of swiping or scrolling horizontally to display different subsets of virtual buttons corresponding to the air quality attributes 578. The second virtual button ribbon 572 displays time periods 580 for selection by a user.

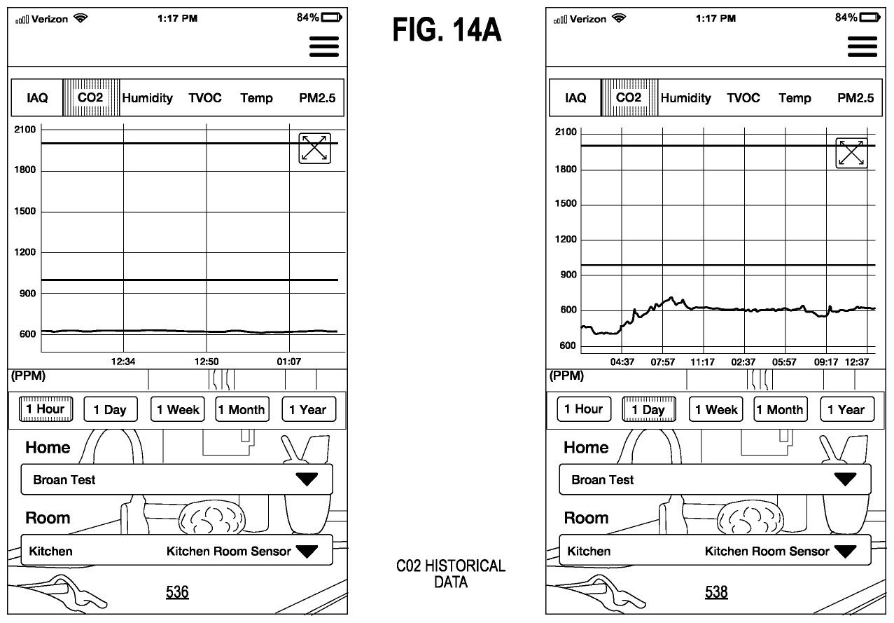

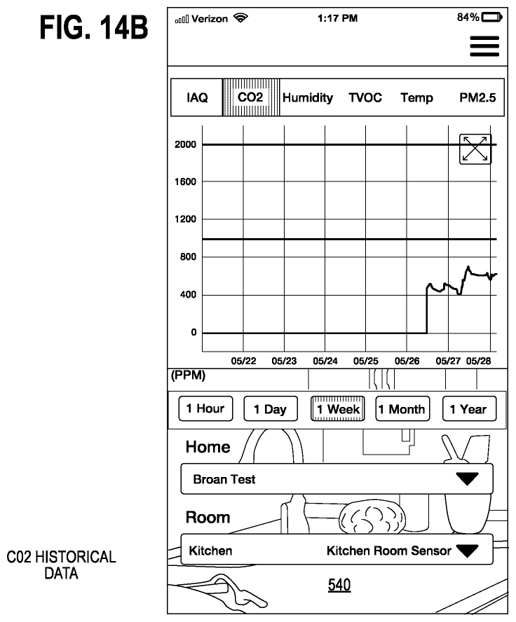

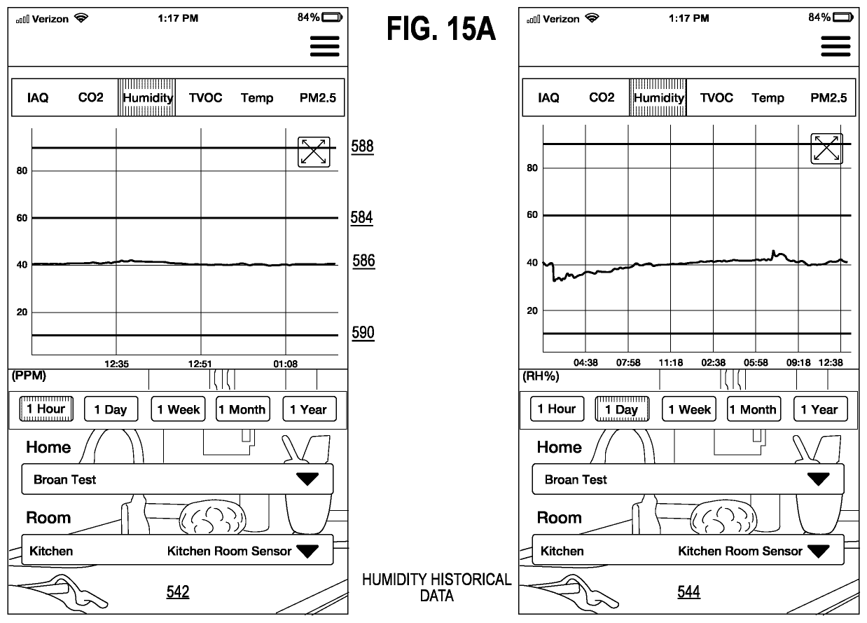

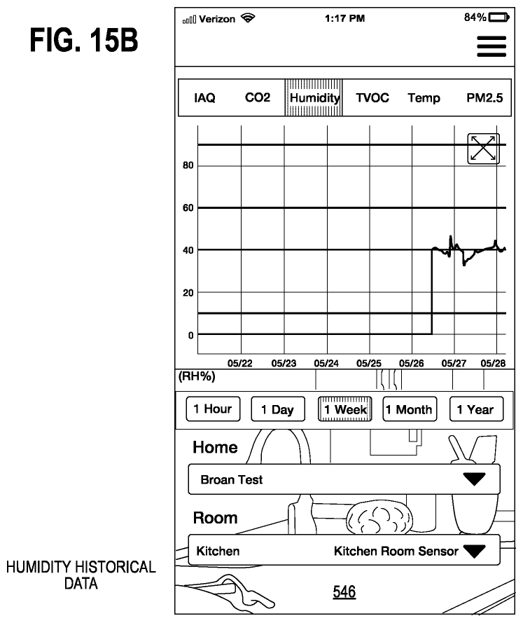

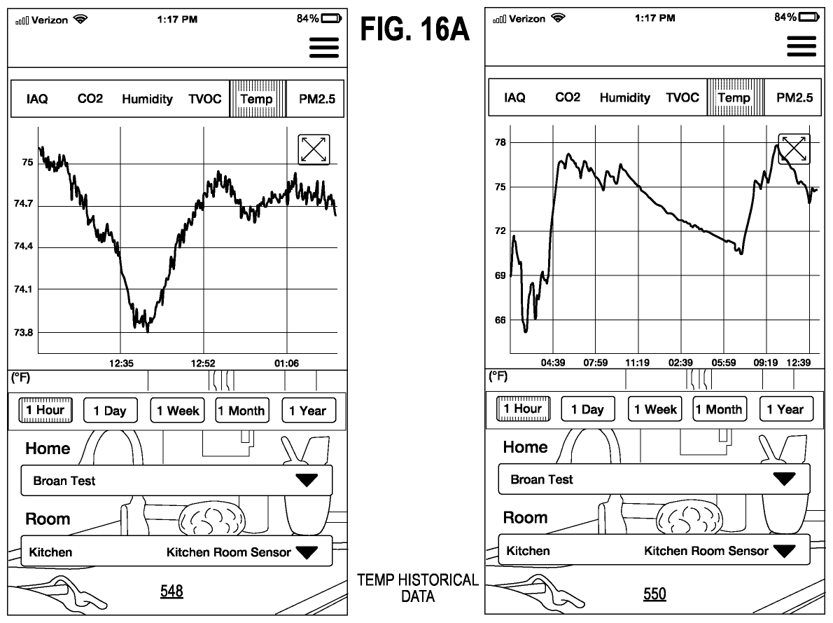

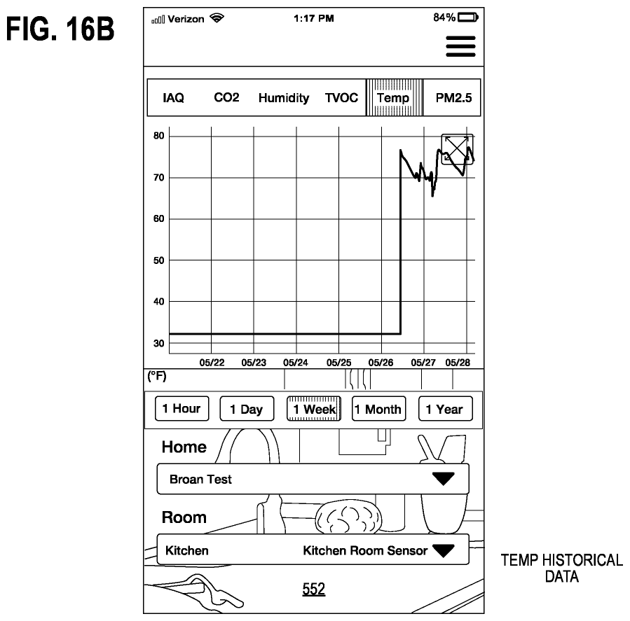

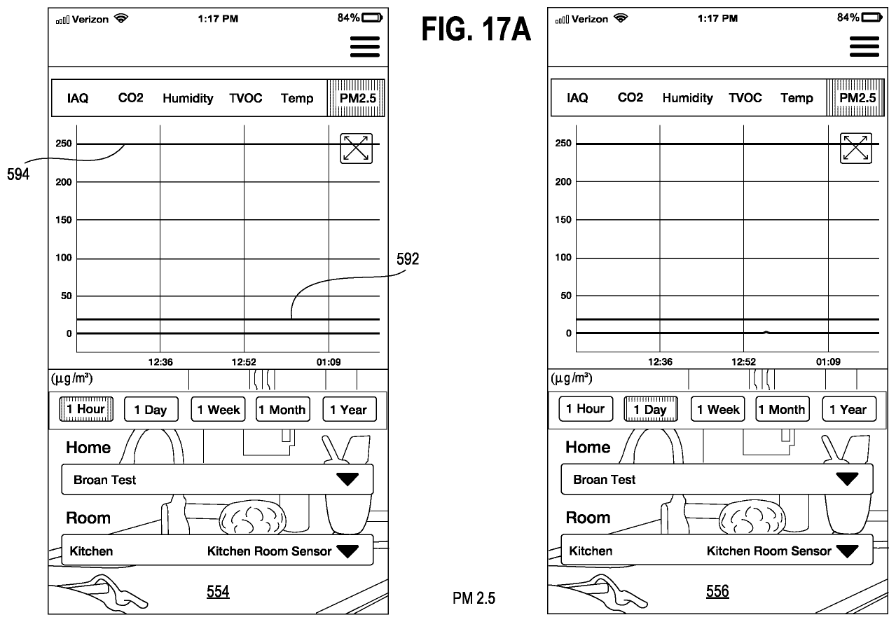

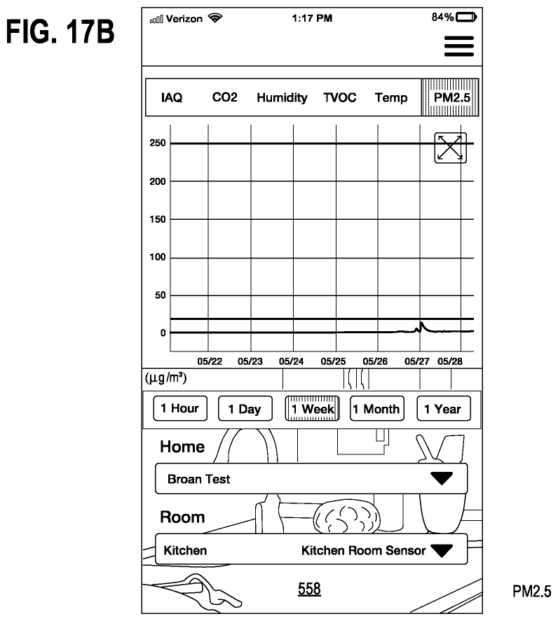

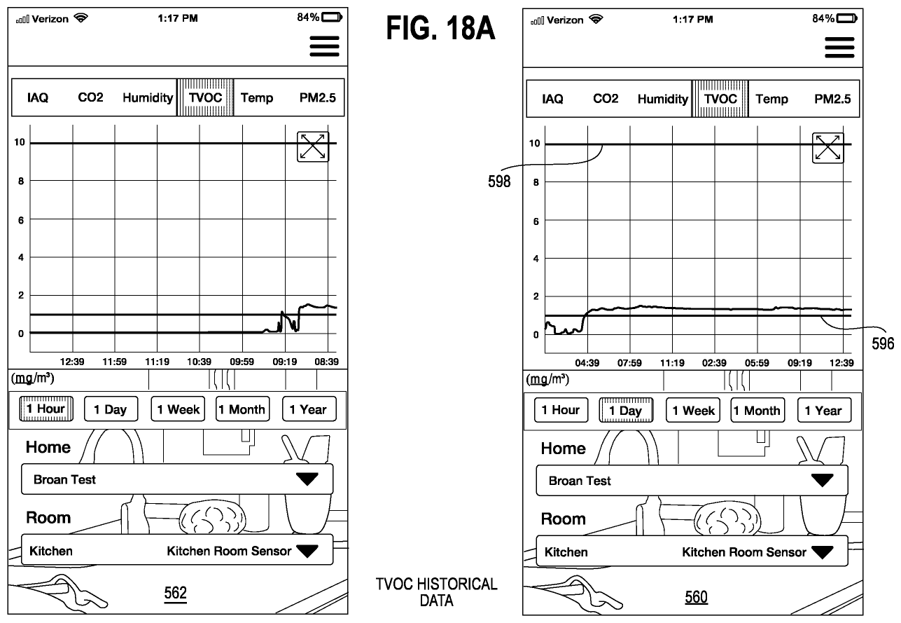

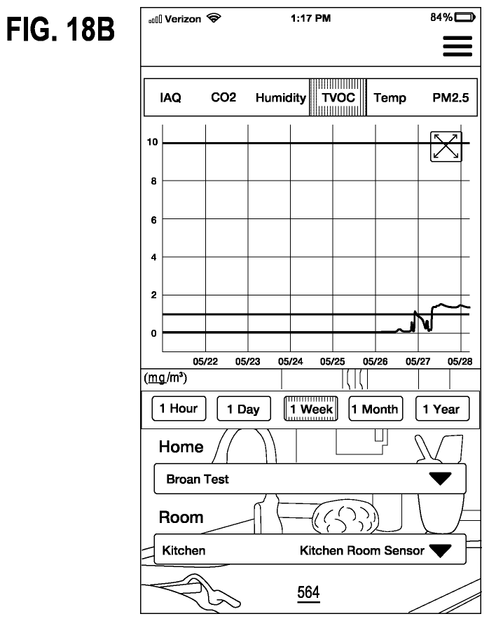

A time period selection from the second virtual button ribbon 572 together with an air quality attribute selection from the first virtual button ribbon 570 defines a graphical representation 582 presented to a user as a component of the user interface configurations 530-562. The graphical representation 582 graphically displays measurement levels of a selected one or more of the air quality attributes 578 over a selected one of the time periods 580. The graphical representation 582 may also display indications of threshold levels. Threshold level indicators may be specific to the air quality attributes 578 and the unique measurement thereof. For example, the CO2 attribute, shown in the user interface configurations 536, 538, 540 of FIGS. 14A and 14B, is compared against a first and second upper threshold limits. In other words, the air quality management system 100 does not have a CO2 range such that CO2 can become low to a point that the system 100 would implement an action. Instead, CO2 levels only trigger actions when the measured levels thereof are too high. In contrast, FIGS. 15A and 15B display a threshold range evaluating humidity levels in the user interface configurations 542, 544, 546. In this example, a first humidity range has upper and lower thresholds 584, 586. Then, a second humidity range has upper and lower thresholds 588, 590 that are, respectively, higher and lower than the thresholds 584, 586 of the first humidity range. Similarly, FIGS. 16A and 16B depict the user interface configurations 548, 550, 552, 554 for user interaction with and monitoring of temperature. In this example, the temperature attribute may respond to a user setting more often than a threshold limit. In exemplary embodiments, user set thresholds may be illustrated along with threshold limits reflecting system user comfort/ASHRAE code/other relevant codes. FIGS. 17A and 17B depict the user interface configurations 554, 556, 558 for interaction with and monitoring of a particulate matter attribute. First and second thresholds 592, 594 are shown in graphical representations of the user interface configurations 554, 556, 558 to signify when a particulate matter attribute level exceeds first and second limits. The first and second thresholds 592, 594 may be interpreted by the air quality control system 100 as triggers for more than one reaction. For example, exceeding the first threshold 592 for particulate matter may warrant remediation by a single fan located in a kitchen. However, exceeding the second threshold 594 may warrant a response by more of the air quality management devices 106 than a kitchen fan. Still further, trends in buildup of particulate matter, humidity, or the like may be acted upon by the air quality management system 100 as a whole, even if detected in only a single room/space or by a single/subset of the air quality management devices 106. In FIGS. 18A and 18B, the user interface configurations 560, 562, 564 facilitate interaction with and monitoring of the TVOC attribute. In a similar manner to the monitoring of PM2.5, the user interface configurations 560, 562, 564 of FIGS. 18A and 18B present first and second thresholds 596, 598 for the TVOC attribute. Referring back to FIGS. 13A and 13B, the user interface configurations 530, 532, 534 show a user selection of the air quality attribute 578 of indoor air quality (IAQ). The indoor air quality attribute may be a composite of a number of the air quality attributes 578 or another metric defined by a government agency such as EPA. ASHRAE 62.2 ventilation requirements or other building code ventilation requirements are periodically monitored by a code ventilation function/process 600 illustrated by the flowchart in FIG. 19. The code ventilation process 600 allows the air quality management system 100 to trigger entry of the system 100 into either a basic routine 602 or an advanced routine 604 for complying with EPA recommendations and/or codes for ventilation requirements. A basic routine may ventilate are for a period of time each hour (or another suitable interval) without regarding for the ventilation history of the air quality management system 100 or measurements of the air quality monitors reading information on air quality attributes into the air quality management system 100. The more advanced routine may consider, for example, whether a bath fan device has recently been run before conducting a routine periodic ventilation of a whole house fan or supply fan and account for any previous activation of ventilation fans connected to the air quality management system to be subtracted from the required ventilation run time of the whole house ventilation fan.

The embodiment(s) described above may be combined in full or in part, with any alternative embodiment(s) described.

### Exemplary System Architecture

Architecturally, the representative technology may be deployed at residential locations or for commercial floorplans. Embodiments of the disclosed system and method 100, 102 are described with reference to FIGS. 1-19. In certain aspects, the system and/or method 100 may be implemented using hardware or a combination of software and hardware, either by dedicated devices and control networks or integrated into other control systems such as centralized HVAC control. Computing device(s) and networks implementing the system and/or method 100 may be, for example, desktop computers, mobile computers, voice-controlled or voice activate devices, mobile devices (e.g., a smartphone or personal digital assistant), or any other devices having appropriate processor, memory, and communications capabilities for implementing the control method 102 and presenting the user interface 116 to one or more users.

According to one aspect of the present disclosure, the disclosed system can be implemented using a computer system in response to a processor executing one or more sequences of one or more instructions contained in memory. Such instructions may be read into memory from another machine-readable medium, such as data storage device. Execution of the sequences of instructions contained in main memory causes the processor to perform the process steps described herein. In alternative implementations, hard-wired circuitry may be used in place of or in combination with software instructions to implement various implementations of the present disclosure. Thus, implementations of the present disclosure are not limited to any specific combination of hardware circuitry and software. The mobile application 114, the first and second networking layers 108, 110, the PIMS 126, and the one or more air quality management devices 106 are controlled by and execute operations partly or wholly stored and executed remotely (e.g., on a server, in the cloud). In exemplary embodiments, the first and second networking layers 108, 110 are disposed on first and second servers. In other exemplary embodiments, the first and second networking layers 108, 110 are implemented on a single server or distrusted across a number of servers. The PIMS 126 may be implemented on a single server or distributed across plural servers, e.g., the PIMS 126 may be instantiated on a single server that accesses a database of product information stored on another server or distributed across plural servers.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode presently known carrying out the disclosure. It should be understood that the illustrated embodiments are exemplary only, and should not be taken as limiting the scope of the disclosure.

What is claimed is:

1. An air quality management system, comprising:
a mobile application distributed to at least one user device;
at least one air quality management device;
at least one computing resource,
wherein the at least one computing resource operates a first networking layer configured to receive input from the at least one mobile application,
wherein the at least one computing resource operates a second networking layer that receives input from the at least one air quality management device;
a data connection between the first and second networking layers to transfer commands of the at least one mobile application from the first networking layer to the second networking layer, and to transfer device information of the at least one air quality management device from the second networking layer to the first networking layer.

2. The air quality management system of claim 1, wherein the computing resource is a server.

3. The air quality management system of claim 1, wherein the first networking layer and the second networking layer are distributed across more than one server.

4. The air quality management system of claim 1, wherein the first networking layer and the second networking layer are implemented locally.

5. The air quality management system of claim 2 further comprising a product information management system that supplies product specifications to the first and second networking layers.

6. The air quality management system of claim 1, wherein the plurality of air quality management devices comprises at least one sensor and at least one ventilation device, and wherein each sensor is linked to at least one ventilation device to control operation thereof.

7. The air quality management system of claim 1, wherein the at least one air quality management device is a plurality of air quality management devices arranged according to a hierarchy configured to determine device states.

8. The air quality management system of claim 7, wherein the plurality of air quality management devices comprises at least one sensor and at least one ventilation device, and wherein each sensor is linked to at least one ventilation device to control operation thereof.

9. The air quality management system of claim 7, wherein the plurality of air quality management devices comprises at least one sensor and at least one fresh air system device, and wherein each sensor is linked to at least one ventilation device to control operation thereof.

10. A method of operating an air quality management system, comprising:
developing a profile of the air quality management system, wherein the profile comprises profile data and profile data comprises identification of a number of air quality management devices, a relative location for the number of air quality management devices, and a location for the air quality management system;
establishing a first user and a second user; and
transferring control of the air quality management system profile from the first user to the second user.

11. The method of operating the air quality management system of claim 10, wherein a mobile application of the air quality management system prompts the first user to conduct the profile developing step.

12. The method of operating the air quality management system of claim 10 further comprises transferring exclusive control of the air quality management system profile from the first user to the second user.

13. The method of operating the air quality management system of claim 10 further comprises transferring guest control of air quality management system profile from the first user to the second user.

14. The method of operating the air quality management system of claim 10, wherein the profile data is used to develop a device hierarchy for the number of air quality management devices.

15. The method of operating the air quality management system of claim 14, wherein the device hierarchy controls a subset of the air quality management devices in response to a current state of another subset of the air quality management devices.

16. A control system for managing at least one air quality management device, comprising:
a mobile application operable by at least one user via a user interface;
a first networking layer that facilitates the mobile application;
a second networking layer that implements a network between the at least one air quality management device;
a communications link between the first networking layer and the second networking layer,
wherein the second networking layer implements operational control of the at least one air quality management device based on information prompted from the at least one user via the user interface.

17. The control system for managing at least one air quality management device of claim 16, wherein the mobile application prompts the at least one user via the user interface to provide:
identification of the at least one air quality management device; and
a relative location of the at least one air quality management device.

18. The control system for managing at least one air quality management device of claim 17, wherein the at least one air quality management device comprises a plurality of air quality management devices wherein the second networking layer establishes a device hierarchy for implementing operational control of the plurality of air quality management devices.

19. The control system for managing at least one air quality management device of claim 18, wherein the device hierarchy is partly based on the relative location of the plurality of air quality management devices.

20. An information management network for air quality management, comprising:
device specifications for a plurality of air quality management devices;
a first networking layer for implementing a mobile application;
a second networking layer for implementing a control system for a structure;
a subset of the plurality of air quality management devices associated with the structure;
a network communications link between the information management network and the first and second networking layers, wherein the first and second networking layers query the information management network for device specifications.

21. The information management network of claim 20, wherein user selections executed in the mobile application and control commands, communicated between the control system and at least one of the subset of the air quality management devices, are developed based on device specifications communicated via the information management network.

22. The information management network of claim 20, wherein the information management network supplies device specifications to the first networking layer to develop a list of air quality management devices, and a mobile application communicatively coupled with the first networking layer is configured to present to a user the list of air quality management devices.

23. The information management network of claim 20, wherein the information management network supplies device specifications to the second networking layer to facilitate identification of the subset of the plurality of air quality management devices associated with a structure.

24. The information management network of claim 23, wherein the device specifications supplied to the second networking layer are used to provide operational limits for customizing control commands to at least one of the subset of air quality management devices associated with the structure.

25. An air quality management system, comprising:
at least one air quality management device;
at least one server,
wherein the at least one server operates a first networking layer configured to receive input from at least one user device,
wherein the at least one server operates a second networking layer that receives input from the at least one air quality management device;
a data connection between the first and second networking layers to transfer information from the at least one user device from the first networking layer to the second networking layer, wherein the at least one air quality management device is assigned one or more link to one of a plurality of air quality management devices identified by the second networking layer.

26. The air quality management system of claim 25, wherein the at least one air quality management device is a ventilation fan.

27. The air quality management system of claim 26, wherein the plurality of air quality management devices comprises at least one sensor that is linked to the at least one air quality management device.

28. The air quality management system of claim 26, wherein the linked one of the plurality of air quality management devices comprises at least one wall switch that is linked to the at least one air quality management device.

29. A method of operating at least one air quality management device, comprising:
identifying an air quality measurement;
setting an air quality measurement threshold;
monitoring an air quality measurement;
comparing the monitored air quality measurement to the air quality measurement threshold;
maintaining a hysteresis value for the comparing step, wherein an amount of time during which the comparing step results in the monitored air quality measurement exceeding the air quality measurement threshold is cumulated during a preselected time period; and
establishing a hysteresis threshold for evaluating the hysteresis value via comparison.

30. The method of operating at least one air quality management device of claim 29, wherein the air quality measurement threshold is adjusted in response to the comparison of the hysteresis value to the hysteresis threshold.

31. The method of operating at least one air quality management device of claim 30, wherein the hysteresis value is an exponential average.

32. The method of operating at least one air quality management device of claim 29, wherein sensitivity of one or more sensors associated with the air quality measurement threshold is adjusted in response to the comparison of the hysteresis value to the hysteresis threshold.

33. The method of operating at least one air quality management device of claim 29, wherein the monitored air quality measurement is humidity, and wherein the comparison of the monitored air quality measurement to the air quality measurement threshold and the comparison of the hysteresis value to the hysteresis threshold indicates a secondary attribute of indoor air quality.
